(19) United States
(12) Patent Application Publication
(10) Pub. No.: US 2013/0200013 A1
(43) Pub. Date: Aug. 8, 2013

(54) OIL AND GAS WELL FILTRATION APPARATUS AND METHOD

(71) Applicant: Robert L. Miller, Florence, CO (US)

(72) Inventor: Robert L. Miller, Florence, CO (US)

(73) Assignee: Jeffrey S. Melcher, Boca Raton, FL (US)

(21) Appl. No.: 13/762,079

(22) Filed: Feb. 7, 2013

Related U.S. Application Data
(60) Provisional application No. 61/596,640, filed on Feb. 8, 2012.

(51) Int. Cl. B01D 17/02

(52) U.S. Cl. CPC B01D 17/02
USPC 210/806; 210/104

(57) ABSTRACT

Provided are an apparatus for filtering water from and oil and gas well and a method of filtering water from an oil and gas well. The filtration unit utilizes gravity fed filtration that is open to the environment.

This application claims priority to U.S. Provisional Patent Application Ser. No. 61/596,640, filed 8 Feb. 2012, the complete disclosure of which is incorporated herein by reference.

### FIELD OF THE INVENTION

The invention relates to an apparatus for filtering waste water from an oil or gas well and a method of filtering waste water from an oil or gas well.

### BACKGROUND OF THE INVENTION

Current filtration systems for cleaning waste water from oil and gas wells simply do not function well and are costly, which is demonstrated by the non-use of such filtrations systems.

The oil and/or gas pumped or flowed from the well usually contains a water residue. This waste water usually contains heavy metals and other contaminants. The waste water then usually flows into a “storage vessel” sometimes called a “Tank Battery”. Currently that solution is being hauled off to storage pits for ineffective “Evaporation”, or is pumped directly back into other wells. This is not being effective at many sites and more pits are being built at a great cost. There is the danger the solution can be blown into the air. The solution can be ridden with contamination that is carried by air currents onto local fields and livestock.

The filtration systems disclosed in my prior U.S. Pat. Nos. 7,998,344; 7,488,418; 7,179,372; 7,175,758; 7,074,337; 7,060,189; and 6,932,910 are incorporated herein by reference.

There is a great need for a simple, efficient, and cost effective filtration system for filtering the waste water from oil and gas wells.

### SUMMARY OF THE INVENTION

An objective of the invention is to provide a filtration system and method for cleaning the waste water that is a byproduct of oil and gas wells (O&G Produced Water).

The objectives are obtained by a recycling apparatus for recycling contaminated water from an oil or gas well comprising:
a holding vessel containing contaminated water from an oil or gas well;
at least first and second main tanks constructed and arranged for holding filtered oil or gas well water and having at least one opening to the environment to allow air to freely transfer between the main tank the environment;
the first main tank having a first filtration system comprising:
   a first filter assembly in gravity feed relation with the first main tank, said first filter assembly having a first filter sheet; and
   a second filter assembly in gravity feed relation with the first main tank, said second filter assembly having a second filter sheet, wherein said first and second filter assemblies are constructed and arranged such that during operation contaminated water flows through the first filter assembly into the second filter assembly and then to the first main tank;
a pump constructed and arranged for transferring contaminated water from the holding vessel to the first filtration system;
the second main tank having a second filtration system comprising:
   a forth filter assembly in gravity feed relation with the main tank, said forth filter assembly having a fourth filter sheet; and
   a fifth filter assembly in gravity feed relation with the main tank, said fifth filter assembly having a fifth filter sheet, wherein said fourth and fifth filter assemblies are constructed and arranged such that during operation contaminated water flows through the fourth filter assembly into the fifth filter assembly and then to the second main tank;
a first fluid level device in the first main tank constructed to measure the level of solution in the first main tank;
a second fluid level device in the second main tank constructed to measure the level of solution in the second main tank;
   a transfer system constructed to pump filtered solution from the first main tank and/or filtered solution from the second main tank to any of the first, second, fourth and fifth filter assemblies.

The objectives are also obtained by a method of recycling a contaminated water solution from an oil or gas well comprising;
transferring contaminated water from an oil or gas well to an oil-water separator;
separating oil from the contaminated water to form an oil reduced water solution;
supplying the oil-reduced water solution to a first filter assembly, which flows successively through the first filter assembly and a second filter assembly and then into a first main tank to form a first filtered solution;
supplying the first filtered solution to a fourth filter assembly, which flows successively through the fourth filter assembly into a fifth filter assembly and then to a second main tank to form a second filtered solution; and
supplying the second filtered solution to at least one of the first, second, fourth, or fifth filter assemblies.

### BRIEF DESCRIPTION OF THE DRAWINGS

FIG. 1 illustrates a side view of a part of an exemplary system according to the present invention.

FIG. 2 illustrates a side view of a part of an exemplary system according to the present invention.

### DETAILED DESCRIPTION OF THE INVENTION

The invention will be explained with reference to the attached non-limiting drawings.

The filtration system can be placed at the well site, or assigned collection center in an enclosed shed. In the storage vessel 50, would be a float system 52 that would allow only the waste water (also referred to as contaminated solution) to be drawn off and sent to the system via a line 54. The float system 52 can include a pump 53 to deliver the contaminated solution to system via line 54.

In a non-limiting example, there are two tanks 2 and 202, which can be formed from any suitable material. The tanks 2 and 202 are preferably formed from steel, or stainless steel. An exemplary size of the tanks 2 and 202 are 3′ tall by 4′ wide by 8′ long, but can vary in size as needed depending on the volume of contaminated solution that has to be treated. Tank 2 is referred to as the cleaner tank and tank 202 is referred to as the scrubber tank. While the tanks 2 and 202 can be identical if desired, the purpose, flow and filter media used in them can be different.

This filtration system can have an Oil-Water Separator (Coalescer, Skimmer, Oil Barrier, etc.) 57 that would be used in conjunction line 54 to remove excess oil from the contaminated solution. The separator system 57 could be mounted on the top of the tank 2 or could be mounted elsewhere. The separator system could be a pit where the oil is allowed to float and be drawn off. A partially submerged sump pump 53 can be placed just above the floor of the pit with its suction being located just below the surface.

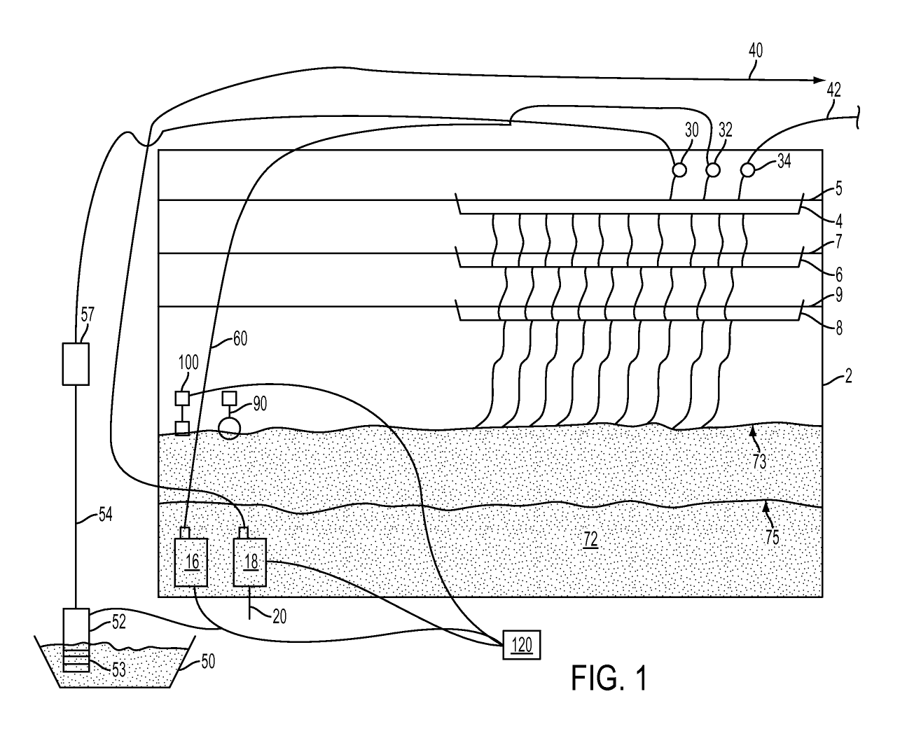

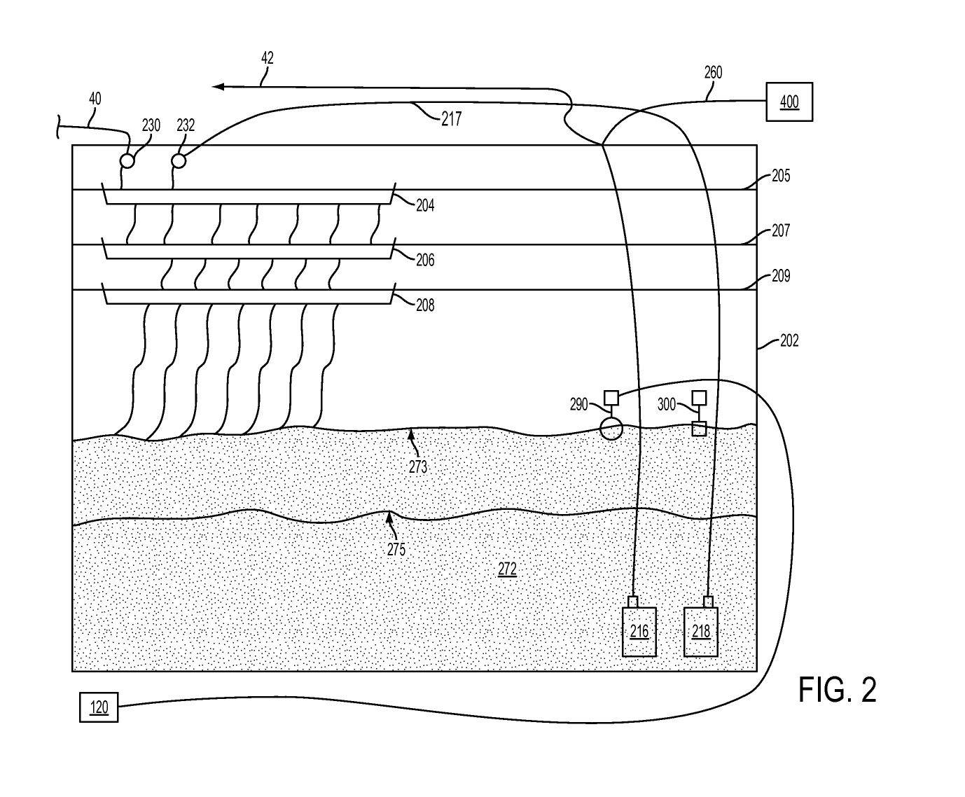

In the exemplary embodiment shown in FIGS. 1 and 2, there are three individual filter trays 4, 6 and 8 in tank 2 and 204, 206 and 208 in tank 202. Each filter tray has an associated filter media disposed in the tray. The filter trays are held in place by associated tray holders 5, 7, 9, 205, 207, and 209. The trays can formed as desired, examples of which are described in my previous patent Nos. 7,998,344; 7,488,418; 7,179,372; 7,175,758; 7,074,337; 7,060,189; and 6,932,910, which are incorporated herein by reference. Any number of filter trays can be used as desired. In this example, the trays were 4 ft wide by 5 ft long with filter media, the material of which can be determined at each site. The filtration media can have different micron sizes and varying types of filter cloth such as, but not limited to, sonic or heat bonded polyester, polyurethane, or other type material as determined necessary to do the function needed. Preferably, at least one sonic or heat bonded polyester filtration media is utilized.

The tank, trays and/or filter media (or other delivery system) could be treated with an anti-microbial to help in treating bacteria. There could also be attached an automatic delivery system using chlorine, iodine, or other preferred anti-microbial form to the system.

The contaminated solution can be pulled or pumped from the storage vessel or pit 50 using a sump pump 52 or other pump system. Alternatively, the filtration system could be low enough for the solution from the pit 50 to flow into it without being pumped.

The solution from the pit 50 would first go through line 54 the first stage spreader tube 30 and be dispersed into the first filter tray 4. The solution flows through the first filter media in the first filter tray 4 by gravity feed into the into and through the second filter media in the second filter tray 6, and then by gravity feed into and through the third filter media in the third filter tray 8 to form a first filtered solution, which drops into the holding area at the bottom of the cleaner tank 2. The recycler pump 16 can recycle part of the first filtered solution 72 on a constant basis through line 60 to spreader tube 32, which disperses the solution to the first filter tray 4.

The first filtered solution 72 can be recycled back through the filter trays 4, 6, and 8 in tank 2 for predetermined amount of time or when any desired condition is met before being released or pumped into the scrubber tank 202. This can be done by regulating the amount of solution 72 being held in tank 2 before part of the solution 72 is pumped by the transfer pump 18 through line 40 into the scrubber tank 202. For example, when the level of solution 72 reaches the amount shown at 73, the pump 18 can be turned on to send solution 72 through line 40 to the spreader tube 230 where it is dispersed into the fourth filter tray 204. The solution 72 flows through the fourth filter media in the fourth filter tray 204, then by gravity feed into and through the fifth filter media in the fifth filter tray 206, then by gravity feed into and through the sixth filter media in the sixth filter tray 209 to form a second filtered solution 272. The solution 272 then falls into the holding area at the bottom of tank 202. When the amount of solution 72 reaches the amount shown at 75, the pump 18 can be shut off.

The recycler/transfer pump 218 can recycle part of the solution 272 on a constant basis through line 217 to spreader tube 232, where solution 272 is dispersed into the fourth filter tray 204. The solution 272 flows through the fourth filter media in the fourth filter tray 204, then by gravity feed into and through the fifth filter media in the fifth filter tray 206, then by gravity feed into and through the sixth filter media in the sixth filter tray 209, and then falls into the holding area at the bottom of tank 202. The solution 272 can be recycled back thru the filters 204, 206, and 208 for a predetermined amount of time or until any desired condition is met before being released through line 260 or pumped through line 42 back to tank 2 via spreader tube 34. A predetermined condition can be determined by regulating the amount of solution 272 being held in the tank 202 before part of the solution 272 is pumped back into the tank 1 or released. For example, when the amount of solution 272 reaches the level shown at 273, the pump 216 can be turned on and when the solution level 272 reaches the amount shown at 275 the pump 216 can be turned off. When the pump 216 is running and the amount of solution 272 is at least the level shown at 273, the solution 272 can be pumped through line 216 to the tank 400. Instead of being pumped by separate pumps, flow switches could be used as desired.

A fluid level device 100 can be used to determine the level of solution 72 for controlling the pump 18. Similarly, a fluid level device 300 can be used to determine the level of solution 272 for controlling the pump 216. The level of the solution 72 can also be monitored using the fluid level device 90 that prevents the tank 2 from being overfilled. The level of the solution 272 can also be monitored using the fluid level device 290 that prevents the tanks 2 from being overfilled. The fluid level devices can be any suitable sensor for measuring the fluid level, which sensors are now well known.

The fluid level devices, pumps, switches, and valves utilized can be connected to a controller and power supply 120.

The system allows for continuous recycling through all six filters before being dumped to its discharge holding area 400 via the discharge pump 216. The embodiments disclosed herein are not limiting. For example, the solutions 72 and 272 can be supplied to any of the filters as desired for the particular application.

Flow meters or other sensors could be used to determine and control the flow of the solution to and from the system. The tanks solution levels in the filter trays and in the tank itself could be monitored using sensors that would be attached to an alarm system. This alarm would then alert the person or entity that would be in charge of the site that there is a problem.

The building that the system can be placed into could be insulated and heated as necessary by solar or other means. The pumps could also be solar powered if necessary.

The oil/gas, as it is pumped out of the well, also pumps out what is now considered “Produced Water” by some states. The production is pumped into a holding tank where it is separated by cooling and settling within the tank. Or if gas, there is currently a gas/water separator process and the water is deposited into a storage tank.

There would be a pump, valve, or other assembly within that tank that would allow the separated water to be delivered to the system. This process could be on a timer control panel that would let in the water and hold it within the system for a determined time for processing. The solution would then be dumped into the local ditch, or could be held as cleaned solution that could be more safely used for dust control, “Fracturing”, etc.

The control pane 120 can be a computer, and also include switches, alarms, timers and communications devices that could notify a central station if there are problems. All of which could be solar or wind powered.

The present system eliminates having to transport the water from the fields to the pits by truck. This transportation is dangerous and very costly in equipment, fuel, manpower, insurance and other costs.

If this system is placed in any building structure, all electrical equipment is preferably explosion resistant or contained outside the building. There would need to be an exhaust fan to make sure there was no build up of explosive or hazardous fumes. All electrical wiring would have to be in the appropriate conduit.

### EXAMPLE

A test unit as shown in FIGS. 1 and 2 was used at the Munro test site.

The first filter media in Tank 1 comprised a 0.5 micron sonic bonded polyester sheet with a second layer under the 0.5 micron sheet of 0.5 micron heat bonded polyester. The second through sixth filter media in Tanks 1 and 2 were 0.02 sonic bonded polyester sheets with 0.5 micron heat bonded polyester sheets under them.

The system surprisingly reduced the amount of elements and oil as shown in Table 1.

TABLE 1

| | | | | | | |
|---|---|---|---|---|---|---|
| Aluminum | 0.979 | <.1 | −89.35 | 0.979 | 0.100 | −89.79 |
| Antimony | <0.3 | <.002 | −99.33 | 0.300 | 0.002 | −99.33 |
| Beryllium | <.100 | <.004 | −96.00 | 0.100 | 0.004 | −96.00 |
| Boron | 20.000 | 17.400 | −13.00 | 20.000 | 17.400 | −13.00 |
| Cadmium | <.1 | 0.005 | −95.00 | 0.100 | 0.005 | −95.50 |
| Chloride | 24,600.000 | 23,400.000 | −4.88 | 24,600.000 | 23,400.000 | −4.88 |
| Chromium | <.1 | <.004 | −96.00 | 0.100 | 0.004 | −96.00 |
| Lead | <.5 | <.0025 | −99.50 | 0.500 | 0.003 | −99.50 |
| Manganese | 0.636 | 0.498 | −21.70 | 0.636 | 0.498 | −21.70 |
| Mercury | <.0001 | <.0001 | 0.00 | 0.000 | 0.000 | 0.00 |
| Molybdenum | <.1 | <.0047 | −95.30 | 0.100 | 0.005 | −95.30 |
| Nickel | <.3 | 0.137 | −54.33 | 0.300 | 0.137 | −54.33 |
| Silver | <.3 | 0.000 | −100.00 | 0.300 | 0.000 | −99.87 |
| Thallium | <.1 | <.001 | −99.00 | 0.100 | 0.001 | −99.00 |
| Zinc | <.3 | 0.028 | −90.67 | 0.300 | 0.028 | −90.80 |
| HEM Oil & Grease | 12.900 | <4.7 | −63.57 | 12.900 | 4.700 | −63.57 |
| TPH-DRO (C10-C28) | 28.300 | 2.000 | −92.93 | 46.300 | 5.460 | −88.21 |
| TPH-GRO (C6-C10) | 40.400 | 15.600 | −61.39 | 48.300 | 2.920 | −93.95 |
| TPH-ORO (>C28-C40) | 2.160 | N/D | −100.00 | 6.890 | 1.900 | −72.42 |

The disclosure herein of the various embodiments is not limited to an individual embodiment but rather said disclosure is intended to apply to any and all embodiments as applicable and appropriate.

I claim:

1. A recycling apparatus for recycling contaminated water from an oil or gas well comprising:
a holding vessel containing contaminated water from an oil or gas well;
at least first and second main tanks constructed and arranged for holding filtered oil or gas well water and having at least one opening to the environment to allow air to freely transfer between the main tank the environment;
the first main tank having a first filtration system comprising:
a first filter assembly in gravity feed relation with the first main tank, said first filter assembly having a first filter sheet; and
a second filter assembly in gravity feed relation with the first main tank, said second filter assembly having a second filter sheet, wherein said first and second filter assemblies are constructed and arranged such that during operation contaminated water flows through the first filter assembly into the second filter assembly and then to the first main tank;
a pump constructed and arranged for transferring contaminated water from the holding vessel to the first filtration system;
the second main tank having a second filtration system comprising:
a forth filter assembly in gravity feed relation with the main tank, said forth filter assembly having a fourth filter sheet; and
a fifth filter assembly in gravity feed relation with the main tank, said fifth filter assembly having a fifth filter sheet, wherein said fourth and fifth filter assemblies are constructed and arranged such that during operation contaminated water flows through the fourth filter assembly into the fifth filter assembly and then to the second main tank;
a first fluid level device in the first main tank constructed to measure the level of solution in the first main tank;
a second fluid level device in the second main tank constructed to measure the level of solution in the second main tank;
a transfer system constructed to pump filtered solution from the first main tank and/or filtered solution from the second main tank to any of the first, second, fourth and fifth filter assemblies.

2. The apparatus according to claim 1, further comprising a third filter assembly in gravity feed relation with the first main tank, said third filter assembly having a third filter sheet, wherein said first, second and third filter assemblies are constructed and arranged such that during operation contaminated water flows through the first filter assembly into the second filter assembly into the third filter assembly and then to the first main tank.

3. The apparatus according to claim 1, wherein at least one of the filter media comprises polyester.

4. The apparatus according to claim 1, further comprising a first pump in the first tank constructed for transferring solution in the first tank to at least one of the fourth and fifth filter assemblies in the second tank.

5. The apparatus according to claim 1, further comprising a second pump in the second tank constructed for transferring solution in the second tank to at least one of the first and second filter assemblies in the first tank.

6. A method of recycling a contaminated water solution from an oil or gas well comprising;
transferring contaminated water from an oil or gas well to an oil-water separator;
separating oil from the contaminated water to form an oil reduced water solution;
supplying the oil-reduced water solution to a first filter assembly, which flows successively through the first filter assembly and a second filter assembly and then into a first main tank to form a first filtered solution;
supplying the first filtered solution to a fourth filter assembly, which flows successively through the fourth filter assembly into a fifth filter assembly and then to a second main tank to form a second filtered solution; and
supplying the second filtered solution to at least one of the first, second, fourth, or fifth filter assemblies.

7. The method according to claim 6, wherein at least one of the filter media comprises polyester.

8. The method according to claim 6, further comprising a first pump in the first tank and using the first pump to transfer solution in the first tank to at least one of the fourth and fifth filter assemblies in the second tank.

9. The method according to claim 6, further comprising a second pump in the second tank and using the second pump to transfer solution in the second tank to at least one of the first and second filter assemblies in the first tank.
